(19) United States
(12) Patent Application Publication
(10) Pub. No.: US 2014/0079951 A1
(43) Pub. Date: Mar. 20, 2014

(54) VINYL CHLORIDE RESIN COMPOSITION FOR ELECTRIC WIRE COATING AND ELECTRIC WIRE USING SAME

(71) Applicant: Yazaki Energy System Corporation, Tokyo (JP)

(72) Inventor: Mitsunori YAMAUCHI, Shizuoka (JP)

(73) Assignee: Yazaki Energy System Corporation, Tokyo (JP)

(21) Appl. No.: 14/088,616

(22) Filed: Nov. 25, 2013

Related U.S. Application Data
(63) Continuation of application No. PCT/JP2012/063542, filed on May 25, 2012.

(30) Foreign Application Priority Data
May 25, 2011 (JP) 2011-117062

(51) Int. Cl. C08K 13/02; H01B 7/02; H01B 3/30; C09D 127/06

(52) U.S. Cl. CPC C08K 13/02; C09D 127/06; H01B 7/02; H01B 3/30
USPC 428/375; 524/400

(57) ABSTRACT

An objective of the present invention is to provide a vinyl chloride resin composition for electric wire coating, which satisfies abrasion resistance and cold resistance specified in ISO 6722 even in the case where it is used in a thin-walled electric wire in accordance with ISO 6722, and an electric wire using the same. In the vinyl chloride resin composition for electric wire coating of the present invention, from 15 to 45 parts by mass of a plasticizer, from 1 to 20 parts by mass of a modifier, from 0.5 to 20 parts by mass of ultrafine silica, and from 2 to 8 parts by mass of a fatty acid metal salt is blended with 100 parts by mass of a vinyl chloride resin.

### CROSS REFERENCE TO RELATED APPLICATION

This application is a continuation of PCT application No. PCT/JP2012/063542, which was filed on May 25, 2012 based on Japanese Patent Application (No. 2011-117062) filed on May 25, 2011, the contents of which are incorporated herein by reference. Also, all the reference cited herein are incorporated as a whole.

### BACKGROUND OF THE INVENTION

1. Technical Field

The present invention relates to a vinyl chloride resin composition for electric wire coating, which is excellent in abrasion resistance and cold resistance, and particularly relates to a vinyl chloride resin composition for electric wire coating having good abrasion resistance and cold resistance even in the case where the composition is used in a thin-walled electric wire in accordance with ISO 6722 that is an international standard.

2. Background Art

For electric wires for low voltage, particularly low-voltage electric wires for automobiles, standards have been hitherto defined by JIS, JASO (Japanese Automotive Standards Organization), and the like. However, since the international standards are integrated into ISO 6722, it is anticipated that low-voltage electric wires for automobiles in accordance with the international standard may become the mainstream hereafter. Of these, with regard to thin-walled type electric wires, since the structure of ISO 6722 standard has a thickness of the coating layer of 0.2 mm, it is practically required to have an excellent abrasion resistance.

For example, in Patent Literature 1(JP-A-H10-241462), a good abrasion resistance has been realized by increasing the hardness of an insulator with using polyvinyl chloride having a Shore D hardness of 72 or more as a main component of the insulator, in such a thin-walled insulated electric wire.

### SUMMARY OF THE INVENTION

However, in the thin-walled insulated electric wire disclosed in Patent Literature 1, since the insulator is hard one, cold resistance is poor and, even when the thickness is 0.2 mm, there is a concern that, when the electric wire is bent after cooling, cracks may be generated at the bent part. For preventing that, it is considered to add MBS (methyl acrylate-butadiene-styrene copolymer), EVA (ethylene-vinyl acetate copolymer), or the like but, when an amount thereof effective for the improvement of cold resistance of the hard insulator is added, it is considered that a problem of decreasing the abrasion resistance owing to softening may occur.

The present invention is devised with focusing on the above problems in the vinyl chloride resin compositions for electric wire coating of the conventional thin-walled insulated electric wires. An object thereof is to provide a vinyl chloride resin composition for electric wire coating, which satisfies abrasion resistance and cold resistance specified in ISO 6722 even in the case where the composition is used in a thin-walled electric wire in accordance with ISO 6722, and an electric wire using the same.

As a result of intensive studies for achieving the above objective, the present inventors have found that a good cold resistance can be obtained without decreasing abrasion resistance by blending certain amounts of a plasticizer, a modifier, ultrafine silica, and a fatty acid metal salt with a vinyl chloride resin as materials of the vinyl chloride resin composition for electric wire coating and thus have accomplished the present invention.

Namely, the objective of the present invention is achieved by the following (1) to (5).

(1) A vinyl chloride resin composition for electric wire coating, which is obtained by blending from 15 to 45 parts by mass of a plasticizer, from 1 to 20 parts by mass of a modifier, from 0.5 to 20 parts by mass of ultrafine silica, and from 2 to 8 parts by mass of a fatty acid metal salt with 100 parts by mass of a vinyl chloride resin.

(2) The vinyl chloride resin composition for electric wire coating as described in (1) above, wherein the blending ratio of the modifier to the ultrafine silica is from 2:1 to 1:1 in terms of mass ratio.

(3) The vinyl chloride resin composition for electric wire coating as described in (1) or (2) above, wherein the plasticizer is one or more selected from the group consisting of phthalate-based plasticizers, trimellitate-based plasticizers, and polyester-based plasticizers.

(4) The vinyl chloride resin composition for electric wire coating as described in any one of (1) to (3) above, wherein the modifier is one or more selected from the group consisting of methyl methacrylate-butadiene-styrene copolymer (MBS), ethylene-methacrylic acid copolymer, and butadiene-acrylonitrile copolymer (NBR).

(5) An electric wire, in which a conductor is coated with a coating layer formed from the vinyl chloride resin composition for electric wire coating as described in any one of (1) to (4) above.

According to the present invention, a vinyl chloride resin composition for electric wire coating, which satisfies abrasion resistance and cold resistance specified in ISO 6722 even in the case where the composition is used in a thin-walled electric wire in accordance with ISO 6722, and an electric wire using the same can be provided.

### DETAILED DESCRIPTION OF THE EXAMPLARY EMBODIMENTS

The following will describe the vinyl chloride resin composition for electric wire coating and the electric wire of the present invention in detail.

[Vinyl Chloride Resin Composition for Electric Wire Coating]

The vinyl chloride resin composition for electric wire coating of the present invention is obtained by blending from 15 to 45 parts by mass of a plasticizer, from 1 to 20 parts by mass of a modifier, from 0.5 to 20 parts by mass of ultrafine silica, and from 2 to 8 parts by mass of a fatty acid metal salt with 100 parts by mass of a vinyl chloride resin.

As the vinyl chloride resin, for example, a usual vinyl chloride resin to be used in insulation applications of electric wires can be used. The degree of polymerization of the vinyl chloride resin to be used is not particularly limited but is preferably from 800 to 1,400 that is a common range of the degree of polymerization.

The plasticizer is blended for imparting flexibility to the resin composition. For example, a phthalate-based plasticizer, a trimellitate-based plasticizer, a polyester-based plasticizer, or a combination thereof can be suitably used.

Examples of the phthalate-based plasticizers include diundecyl phthalate, ditridecyl phthalate, di-2-ethylhexyl phthalate, di-n-octyl phthalate, diisononyl phthalate, di-n-decyl phthalate, diisodecyl phthalate, and the like. Examples of the trimellitate-based plasticizers include tri-2-ethylhexyl trimellitate, tri-n-octyl trimellitate, triisodecyl trimellitate, tri-n-octyl trimellitate, and the like. Examples of the polyester-based plasticizers include poly(1,3-butane diol adipate) and the like. Of these, from the viewpoint of cold resistance, it is preferred to use diundecyl phthalate or the like.

The plasticizer is blended so that it is from 15 to 45 parts by mass, and it is preferably from 20 to 45 parts by mass, more preferably from 20 to 40 parts by mass, relative to 100 parts by mass of the vinyl chloride resin. By blending the plasticizer so that the amount thereof falls within the range, a good processability can be imparted without impairing good general physical properties, especially strength.

The modifier is blended for improving brittleness of the resin composition under low-temperature conditions. In the present invention, the “low-temperature” is not particularly limited but means a temperature of about −40° C.

The modifier is not particularly limited but, for example, methyl methacrylate-butadiene-styrene copolymer (MBS), ethylene-methacrylic acid copolymer, or butadiene-acrylonitrile copolymer (NBR), or a combination thereof can be suitably used. Examples of commercially available methyl methacrylate-butadiene-styrene copolymer include “Metablen C223A” manufactured by Mitsubishi Rayon Co., Ltd. and the like. Examples of commercially available ethylene-methacrylic acid copolymer include “Nucrel NO903HC” manufactured by Dupont-Mitsui Polychemicals Co., Ltd. and the like. Examples of commercially available butadiene-acrylonitrile copolymer include “JSR N220SH” manufactured by JSR Corporation and the like. Of these, from the viewpoint of cold resistance, it is preferred to use MBS resin.

The blending amount of the modifier is from 1 to 20 parts by mass, and is preferably from 1 to 15 parts by mass, more preferably from 3 to 15 parts by mass, relative to 100 parts by mass of the vinyl chloride resin. By blending the modifier so that the amount falls within the range, the cold resistance under low-temperature conditions can be improved while avoiding excessive softening of the resin composition and a decrease in abrasion resistance of the resin composition.

The ultrafine silica is blended for reducing the softening of the resin composition caused by the blending of the modifier. The average particle diameter of the ultrafine silica to be used in the present invention is preferably from 5 to 100 nm, more preferably from 10 to 20 nm. Moreover, bulk specific gravity of the ultrafine silica is preferably from 10 to 100 g/cm³, more preferably from 50 to 70 g/cm³. By using the ultrafine silica having physical properties falling within the above ranges, the hardness of the resin composition can be increased. Examples of commercially available products of the ultrafine silica include “Aerosil (registered trademark) 200” manufactured by Nippon Aerosil Co., Ltd.

The blending amount of the ultrafine silica is from 0.5 to 20 parts by mass, and is preferably from 1 to 15 parts by mass, more preferably from 1 to 10 parts by mass, relative to 100 parts by mass of the vinyl chloride resin. By blending the ultrafine silica so that it falls within the above range, the hardness of the vinyl chloride resin composition for electric wire coating can be increased and the abrasion resistance can be improved.

In the present invention, the modifier and the ultrafine silica are preferably blended in a ratio of 2:1 to 1:1. By blending them so that the ratio falls within the range, a sufficient hardness can be maintained and the abrasion resistance can be improved even when the filling amount of the bulky (i.e., small bulk specific gravity) ultrafine silica is as small as possible.

The fatty acid metal salt is blended for preventing the aggregation of the ultrafine silica and satisfactorily dispersing it.

Examples of the fatty acid metal salt include calcium stearate, zinc stearate, and the like. Of these, from the viewpoint of dispersibility, it is preferred to use calcium stearate. The blending amount of the fatty acid metal salt is from 2 to 8 parts by mass, and is preferably from 2 to 6 parts by mass, more preferably from 2 to 5 parts by mass, relative to 100 parts by mass of the vinyl chloride resin.

Moreover, in order to suppress the thermal decomposition of the resin by heat at the time when various raw materials of the vinyl chloride resin composition are compounded, it is preferred to blend a stabilizer therewith.

As the stabilizer, from the viewpoints of thermal stability and toxicity, those containing no lead and cadmium and containing hydrotalcite are preferred. As the stabilizer, for example, a mixture of hydrotalcite and zinc stearate or the like can be used and as commercially available one, “RUP 103” manufactured by ADEKA Corporation may be mentioned. The stabilizer is preferably blended in an amount of 5 to 15 parts by mass, and the amount is more preferably from 5 to 12 parts by mass, further preferably from 5 to 10 parts by mass, relative to 100 parts by mass of the vinyl chloride resin.

With the vinyl chloride resin composition for electric wire coating of the present invention, additives such as a filler, a flame retardant, a processing aid, and a coloring agent may be further blended according to need.

Examples of the filler may include calcium carbonate and the like. Examples of the flame retardant may include magnesium hydroxide and the like. Examples of the processing aid may include poly(methyl methacrylate) (PMMA) and the like. Examples of the coloring agent may include carbon black and the like.

The crosslinked vinyl chloride resin composition of the present invention can be obtained by crosslinking after molding. As the method for crosslinking, any conventionally known methods can be used without particular limitation and methods such as chemical crosslinking, silane crosslinking, and radiation crosslinking can be employed. Particularly, a method using an electron beam is preferable in view of management and cost.

[Electric Wire]

The electric wire of the present invention is an electric wire in which a conductor is coated with a coating layer formed from the aforementioned vinyl chloride resin composition for electric wire coating of the present invention. The vinyl chloride resin composition may be directly applied on the conductor or may be applied as a sheath material on a usual insulated electric wire. The electric wire of the present invention can be obtained by crosslinking the vinyl chloride resin by a method of electron beam irradiation or the like after coating as an insulating layer or a sheath layer by a molding method such as extrusion coating. The thickness of the coating layer is about 0.2 mm in accordance with ISO 6722.

### EXAMPLES

The following will describe the present invention in further detail with reference to Examples and Comparative Examples, but the present invention is not limited to these Examples. Incidentally, the blending amounts are represented in terms of “part(s) by mass” unless otherwise stated.

With regard to Examples 1 to 12 and Comparative Examples 1 to 6, respective materials shown in Tables 1 and 2 were blended in ratios described, and kneaded and mixed in an open mixer to form pellets, whereby vinyl chloride resin compositions before crosslinking were obtained. The vinyl chloride resin compositions obtained were molded by a melt-extrusion method and crosslinked to prepare an ultrathin-walled electric wire having a coating thickness of 0.2 mm conforming to ISO 6722 standard. The electric wires of individual examples were subjected to tests for hardness, cold resistance, and abrasion resistance.

Details of the materials shown in Tables are described below.

A) Vinyl chloride resin: TH-1300 (manufactured by Taiyo Vinyl Corporation); degree of polymerization 1300

B) Plasticizer: diundecyl phthalate (DUP) (manufactured by J-PLUS Co., Ltd.)

C) Modifier: methyl methacrylate-butadiene-styrene copolymer (manufactured by Mitsubishi Rayon Co., Ltd.)

D) Ultrafine silica: Aerosil (registered trademark) 200 (manufactured by Nippon Aerosil Co., Ltd.) ; average particle diameter: 12 nm, bulk specific gravity: 50 g/cm³

E) Fatty acid metal salt: calcium stearate (manufactured by Sakai Chemical Industry Co., Ltd.)

F) Stabilizer: hydrotalcite (75%), zinc stearate (25%)

G) Calcium carbonate: Esukaron #1500 (manufactured by Sankyo Seifun K. K.)

<Hardness Test>

With regard to hardness, the D hardness test specified in JIS K 7215 was performed. The results are shown in Tables 1 and 2.

<Cold Resistance Test>

With regard to cold resistance, low-temperature characteristics were tested by the method specified in ISO 6722. The results are shown in Tables 1 and 2.

<Abrasion Resistance Test>

With regard to abrasion resistance, the scrape abrasion test specified in ISO 6722 was performed. The results are shown in Tables 1 and 2.

TABLE 1
(unit: part(s) by mass)

| | Example | | | | | | | | | | | |
|---|---|---|---|---|---|---|---|---|---|---|---|---|
| | 1 | 2 | 3 | 4 | 5 | 6 | 7 | 8 | 9 | 10 | 11 | 12 |
| A: Vinyl chloride resin | 100 | 100 | 100 | 100 | 100 | 100 | 100 | 100 | 100 | 100 | 100 | 100 |
| B: Plasticizer | 15 | 15 | 45 | 45 | 15 | 45 | 15 | 15 | 45 | 45 | 15 | 45 |
| C: Modifier | 20 | 1 | 20 | 1 | 20 | 1 | 20 | 1 | 20 | 1 | 20 | 1 |
| D: Ultrafine silica | 10 | 0.5 | 10 | 0.5 | 10 | 0.5 | 20 | 1 | 20 | 1 | 20 | 1 |
| E: Fatty acid metal salt | 8 | 2 | 8 | 2 | 2 | 8 | 8 | 2 | 8 | 2 | 2 | 8 |
| F: Stabilizer | 5 | 5 | 5 | 5 | 5 | 5 | 5 | 5 | 5 | 5 | 5 | 5 |
| G: Calcium carbonate | 5 | 5 | 5 | 5 | 5 | 4 | 5 | 5 | 5 | 5 | 5 | 4 |
| C/D ratio | 2:1 | 2:1 | 2:1 | 2:1 | 2:1 | 2:1 | 1:1 | 1:1 | 1:1 | 1:1 | 1:1 | 1:1 |
| Hardness | 70 | 73 | 45 | 45 | 68 | 46 | 72 | 73 | 46 | 45 | 70 | 46 |
| Cold resistance (° C.) | −55 | −40 | −70 | −50 | −40 | −55 | −55 | −40 | −70 | −50 | −40 | −55 |
| Abrasion resistance | 580 | 950 | 340 | 350 | 510 | 320 | 550 | 945 | 320 | 345 | 490 | 315 |
| (times) | | | | | | | | | | | | |

TABLE 2
(unit: part(s) by mass)

| | Comparative Example | | | | | |
|---|---|---|---|---|---|---|
| | 1 | 2 | 3 | 4 | 5 | 6 |
| A: Vinyl chloride resin | 100 | 100 | 100 | 100 | 100 | 100 |
| B: Plasticizer | 15 | 50 | 15 | 50 | 15 | 50 |
| C: Modifier | 20 | 20 | 1 | 1 | — | — |
| D: Ultrafine silica | — | — | — | — | 0.5 | 10 |
| E: Fatty acid metal salt | 2 | 8 | 2 | 8 | 8 | 8 |
| F: Stabilizer | 5 | 5 | 5 | 5 | 5 | 5 |
| G: Calcium carbonate | 5 | 5 | 5 | 5 | 5 | 5 |
| C/D ratio | — | — | — | — | — | — |
| Hardness | 66 | 41 | 72 | 43 | 72 | 45 |
| Cold resistance (° C.) | −40 | −70 | −20 | −50 | −20 | −50 |
| Abrasion resistance | 280 | 140 | 1300 | 240 | 1500 | 280 |
| (times) | | | | | | |

From the results in Tables 1 and 2, it is seen that the electric wires coated with the vinyl chloride resin compositions of the present invention (Examples 1 to 12) all have cold resistance of −40° C. or lower and also 300 times or more are observed until the conductor is exposed in the scrape abrasion test and thus the wires are also excellent in abrasion resistance, as compared with Comparative Examples 1 to 6. Therefore, it can be confirmed that the vinyl chloride resin composition of the present invention has characteristics having a good balance of cold resistance and abrasion resistance.

Here, characteristics of the vinyl chloride resin composition for electric wire coating according to the present invention and the electric wire using the same are collectively listed in the following articles of (I) to (VIII).

(I) A vinyl chloride resin composition for electric wire coating, which is obtained by blending from 15 to 45 parts by mass of a plasticizer, from 1 to 20 parts by mass of a modifier, from 0.5 to 20 parts by mass of ultrafine silica, and from 2 to 8 parts by mass of a fatty acid metal salt with 100 parts by mass of a vinyl chloride resin.

(II) The vinyl chloride resin composition for electric wire coating of (I) above, wherein the blending ratio of the modifier to the ultrafine silica is from 2:1 to 1:1 in terms of mass ratio.

(III) The vinyl chloride resin composition for electric wire coating of (I) above, wherein the plasticizer is one or more selected from the group consisting of phthalate-based plasticizers, trimellitate-based plasticizers, and polyester-based plasticizers.

(IV) The vinyl chloride resin composition for electric wire coating of (I) above, wherein the modifier is one or more selected from the group consisting of methyl methacrylate-butadiene-styrene copolymer (MBS), ethylene-methacrylic acid copolymer, and butadiene-acrylonitrile copolymer (NBR).

(V) An electric wire, in which a conductor is coated with a coating layer formed from a vinyl chloride resin composition for electric wire coating which is obtained by blending from 15 to 45 parts by mass of a plasticizer, from 1 to 20 parts by mass of a modifier, from 0.5 to 20 parts by mass of ultrafine silica, and from 2 to 8 parts by mass of a fatty acid metal salt with 100 parts by mass of a vinyl chloride resin.

(VI) The electric wire of (V) above, wherein the blending ratio of the modifier to the ultrafine silica is from 2:1 to 1:1 in terms of mass ratio.

(VII) The electric wire of (V) above, wherein the plasticizer is one or more selected from the group consisting of phthalate-based plasticizers, trimellitate-based plasticizers, and polyester-based plasticizers.

(VIII) The electric wire of (V) above, wherein the modifier is one or more selected from the group consisting of methyl methacrylate-butadiene-styrene copolymer (MBS), ethylene-methacrylic acid copolymer, and butadiene-acrylonitrile copolymer (NBR).

While the present invention has been described in detail and with reference to specific embodiments thereof, it will be apparent to one skilled in the art that various changes and modifications can be made therein without departing from the spirit and scope of the present invention.

The present invention can be utilized in the production fields of low-pressure thin-walled electric wires for automobiles and the like, insulation coating thereof, and the like.

What is claimed is:

1. A vinyl chloride resin composition for electric wire coating, which comprises;
from 15 to 45 parts by mass of a plasticizer;
from 1 to 20 parts by mass of a modifier;
from 0.5 to 20 parts by mass of ultrafine silica having an average particle diameter of from 5 to 100 nm; and
from 2 to 8 parts by mass of a fatty acid metal salt;
relative to 100 parts by mass of a vinyl chloride resin.

2. The vinyl chloride resin composition for electric wire coating according to claim 1, wherein the blending ratio of the modifier to the ultrafine silica is from 2:1 to 1:1 in terms of mass ratio.

3. The vinyl chloride resin composition for electric wire coating according to claim 1, wherein the plasticizer is one or more selected from the group consisting of phthalate-based plasticizers, trimellitate-based plasticizers, and polyester-based plasticizers.

4. The vinyl chloride resin composition for electric wire coating according to claim 1, wherein the modifier is one or more selected from the group consisting of methyl methacrylate-butadiene-styrene copolymer (MBS), ethylene-methacrylic acid copolymer, and butadiene-acrylonitrile copolymer (NBR).

5. An electric wire, in which a conductor is coated with a coating layer formed from a vinyl chloride resin composition for electric wire coating, comprising;
from 15 to 45 parts by mass of a plasticizer;
from 1 to 20 parts by mass of a modifier;
from 0.5 to 20 parts by mass of ultrafine silica having an average particle diameter of
from 5 to 100 nm; and
from 2 to 8 parts by mass of a fatty acid metal salt;
relative to 100 parts by mass of a vinyl chloride resin.

6. The electric wire according to claim 5, wherein the blending ratio of the modifier to the ultrafine silica is from 2:1 to 1:1 in terms of mass ratio.

7. The electric wire according to claim 5, wherein the plasticizer is one or more selected from the group consisting of phthalate-based plasticizers, trimellitate-based plasticizers, and polyester-based plasticizers.

8. The electric wire according to claim 5, wherein the modifier is one or more selected from the group consisting of methyl methacrylate-butadiene-styrene copolymer (MBS), ethylene-methacrylic acid copolymer, and butadiene-acrylonitrile copolymer (NBR).
